(19) United States
(12) Patent Application Publication
(10) Pub. No.: US 2015/0248546 A1
(43) Pub. Date: Sep. 3, 2015

(54) Display Operation Apparatus, Display Operation Method, and Recording Medium That Ensure Safe and Accurate Confirmation of Registration Information Registered In Card

(71) Applicant: KYOCERA DOCUMENT SOLUTIONS INC., Osaka (JP)

(72) Inventor: Sumio Yamada, Osaka (JP)

(21) Appl. No.: 14/634,760

(22) Filed: Feb. 28, 2015

(30) Foreign Application Priority Data
Feb. 28, 2014 (JP) 2014-038406

(51) Int. Cl. G06F 21/34; G06F 21/62

(52) U.S. Cl. CPC G06F 21/34; G06F 21/6245

(57) ABSTRACT

A display operation apparatus using a card includes a first registration information display unit, a user authentication unit, and a second registration information display unit. The first registration information display unit displays card information related to the card as first registration information corresponding to user identification information and card identification information of the card when the user identification information and the card identification information are read. The user authentication unit executes user authentication after the first registration information is displayed. The second registration information display unit displays personal information of an owner of the card as second registration information corresponding to the user identification information and the card identification information when login is executed as a result of the user authentication.

### INCORPORATION BY REFERENCE

This application is based upon, and claims the benefit of priority from, corresponding Japanese Patent Application No. 2014-038406 filed in the Japan Patent Office on Feb. 28, 2014, the entire contents of which are incorporated herein by reference.

### BACKGROUND

Unless otherwise indicated herein, the description in this section is not prior art to the claims in this application and is not admitted to be prior art by inclusion in this section.

Recently an authentication card for user authentication has become widespread and a various kind of technique exists for an apparatus requiring user authentication. For example, an authentication apparatus performing user authentication using a login name and a password is disclosed. In this apparatus, when a user carrying an IC card capable of transmitting an identification signal by wireless communications approaches the apparatus, the apparatus displays only the login name on an operation panel and becomes a state being acceptable of the password. Further, in this apparatus, when the user leaves proximity of this apparatus, this apparatus halts a display of the login name and ensures improvement of security.

### SUMMARY

A display operation apparatus using a card according to one aspect of the disclosure includes a first registration information display unit, a user authentication unit, and a second registration information display unit. The first registration information display unit displays card information related to the card as first registration information corresponding to user identification information and card identification information of the card when the user identification information and the card identification information are read. The user authentication unit executes user authentication after the first registration information is displayed. The second registration information display unit displays personal information of an owner of the card as second registration information corresponding to the user identification information and the card identification information when login is executed as a result of the user authentication.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an outline of a multi-functional peripheral including a display operation apparatus according to one embodiment of the disclosure.

FIG. 2 illustrates an overall configuration of the display operation apparatus according to the one embodiment.

FIG. 3 illustrates a configuration of control system hardware of the multi-functional peripheral and a display operation unit according to the one embodiment.

FIG. 4 illustrates a function block configuration of the multi-functional peripheral and the display operation unit according to the one embodiment.

FIG. 5 illustrates an execution procedure of the one embodiment.

FIG. 6A illustrates an exemplary registration table according to the one embodiment.

FIG. 6B illustrates an exemplary first registration information display screen according to the one embodiment.

FIG. 6C illustrates an exemplary second registration information display screen according to of the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

An embodiment of a display operation apparatus of the disclosure will be described below with reference to attached drawings and ensures understanding of the disclosure. Additionally, the following embodiment is one example of the embodied disclosure and does not have a nature limiting a technical range of the disclosure. Further, an alphabet S attached before a numeral in a flowchart means a step.

### Display Operation Apparatus

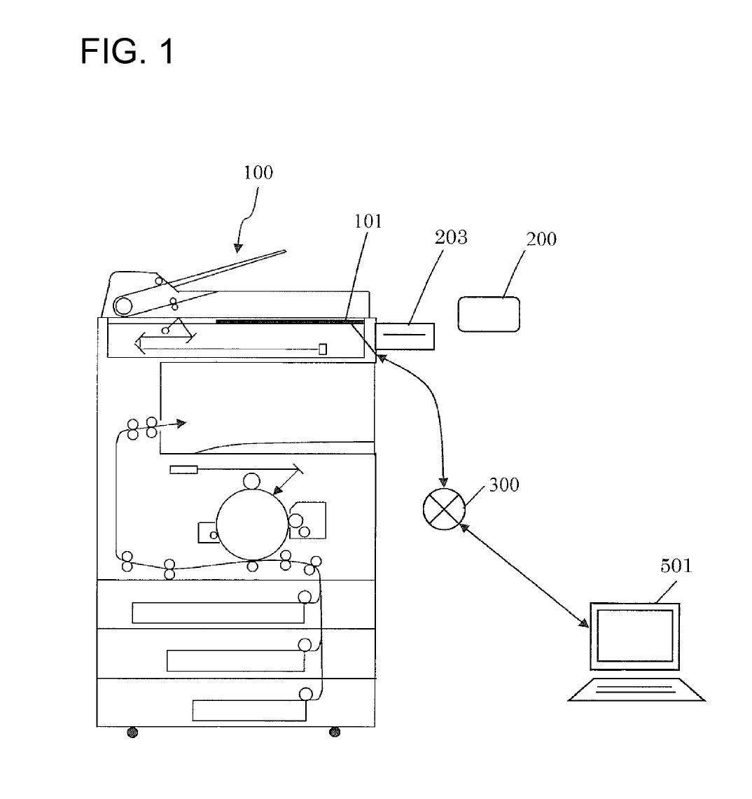

As one example of the display operation apparatus (a display operation unit) according to embodiment of the disclosure, the following describes an image forming apparatus including the display operation unit. FIG. 1 is a schematic diagram of the image forming apparatus according to the embodiment of the disclosure. However, the detail of the respective portions that does not directly relate to the disclosure is omitted. Additionally, the image forming apparatus of the disclosure corresponds to, for example, a multi-functional peripheral including functions, such as copying, scanner, and printer.

Assume that, for example, when a user, with an electronic card for user authentication, goes to a multi-functional peripheral 100 (MFP) and uses the multi-functional peripheral 100. In this case, the user inserts user's own electronic card 200 into a card reader 203 preliminarily located in the multi-functional peripheral 100 and causes the card reader 203 to read user identification information in the electronic card 200.

The card reader 203 is connected to a display operation unit 101 (an operation panel). In the multi-functional peripheral 100, the display operation unit 101 executes user authentication based on the user identification information read by the card reader 203.

When user authentication is succeeded, for example, since the display operation unit 101 displays an operation screen, the user inputs a predetermined setting condition looking at the operation screen and causes a print job to be executed.

The multi-functional peripheral 100 includes an image reading unit, an image forming unit, a conveying unit, and a fixing unit and executes the print job by causing the respective units to operate together.

In addition, the display operation unit 101 of the multi-functional peripheral 100 is connected to a predetermined terminal device 501 (for example, a server) via a network 300, and the display operation unit 101 is capable of reading and writing predetermined information from and to the terminal device 501 via the network 300, based on the user identification information.

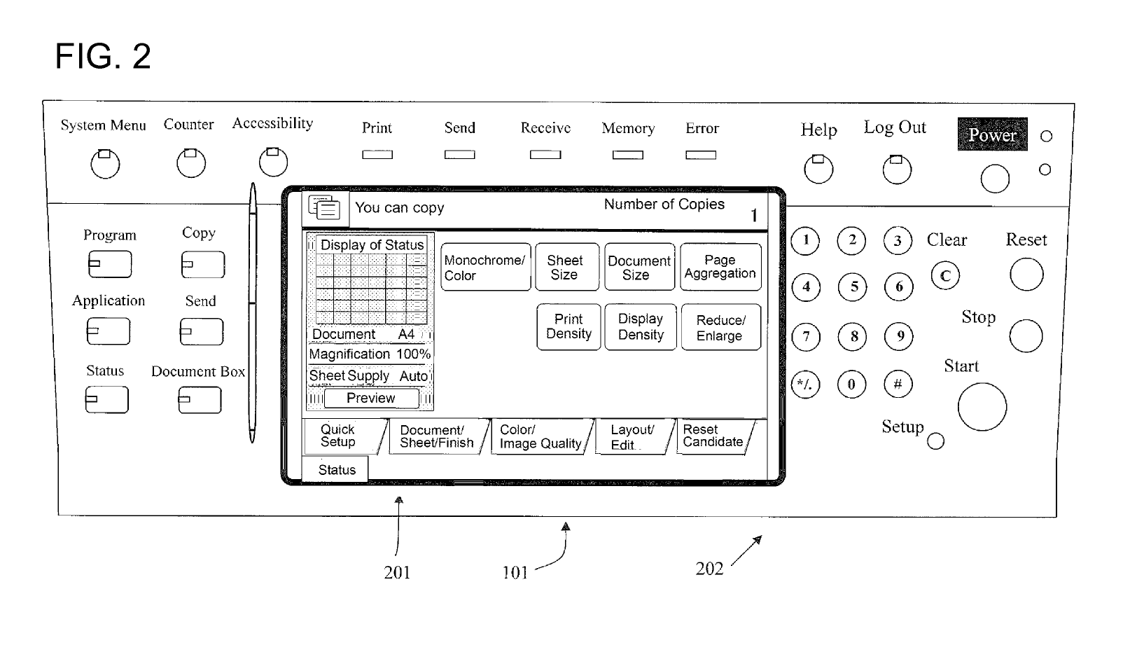

Next, FIG. 2 is a conceptual diagram illustrating an overall configuration of the display operation unit according to the embodiment of the disclosure. The user confirms the predetermined operation screen and input the predetermined information using the display operation unit 101. In this display operation unit 101, a touch panel 201 (operation panel) and an operation key 202 are located.

In the touch panel 201, a predetermined screen is displayed and, by keys in the displayed screen being pressed, the information corresponding to the pressed key is input.

In the operation key 202, for example, a numeric keypad, a start key, a clear key, a stop key, a reset key, a power key, and a similar key are included.

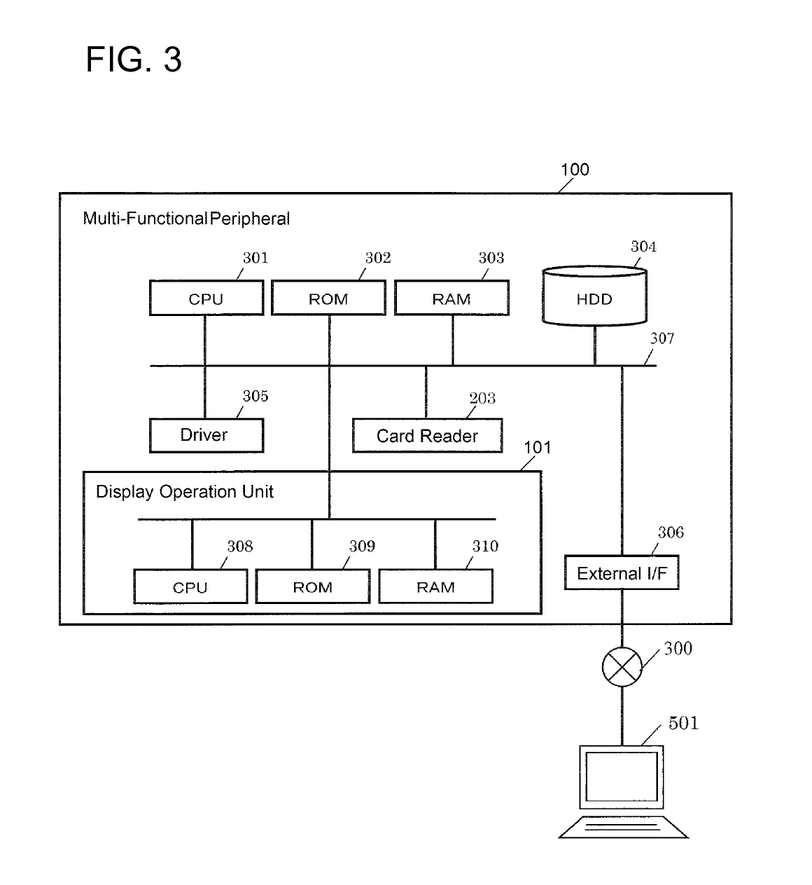

Next, with use of FIG. 3, the configuration of control system hardware of the multi-functional peripheral 100 and display operation unit 101 will be described. FIG. 3 is a diagram illustrating the configuration of the control system hardware of the multi-functional peripheral 100 and the display operation unit 101 according to the disclosure. However, the detail of the respective units that does not directly relate to the disclosure is omitted.

In a control circuit of the multi-functional peripheral 100, a Central Processing Unit (CPU) 301, a Read Only Memory (ROM) 302, a Random Access Memory (RAM) 303, a Hard Disk Drive (HDD) 304, a driver 305 corresponding to the respective driving units, the display operation unit 101, the card reader 203, and an external interface 306 are connected by an internal bus 307.

The CPU 301, for example, with the use of the RAM 303 as a work area, executes programs stored in the ROM 302, the HDD 304, and a similar device. Then, the CPU 301 transmits or receives data, instructions, signals, commands, and similar information from the driver 305, the display operation unit 101, the card reader 203, and the external interface 306 based on the execution result and controls the performance of the respective driving units illustrated in FIG. 1. Further, the display operation unit 101 includes a CPU 308, a ROM 309, and a RAM 310, and the function of the respective portions is similar to the above-described function.

Meanwhile, the external interface 306 is communicatively connected to the terminal device 501 via the network 300, and, in a control circuit of the terminal device 501, though not illustrated, a CPU, a ROM, a RAM, a HDD, and an external interface are located. The function of the respective portions is similar to the above-described function.

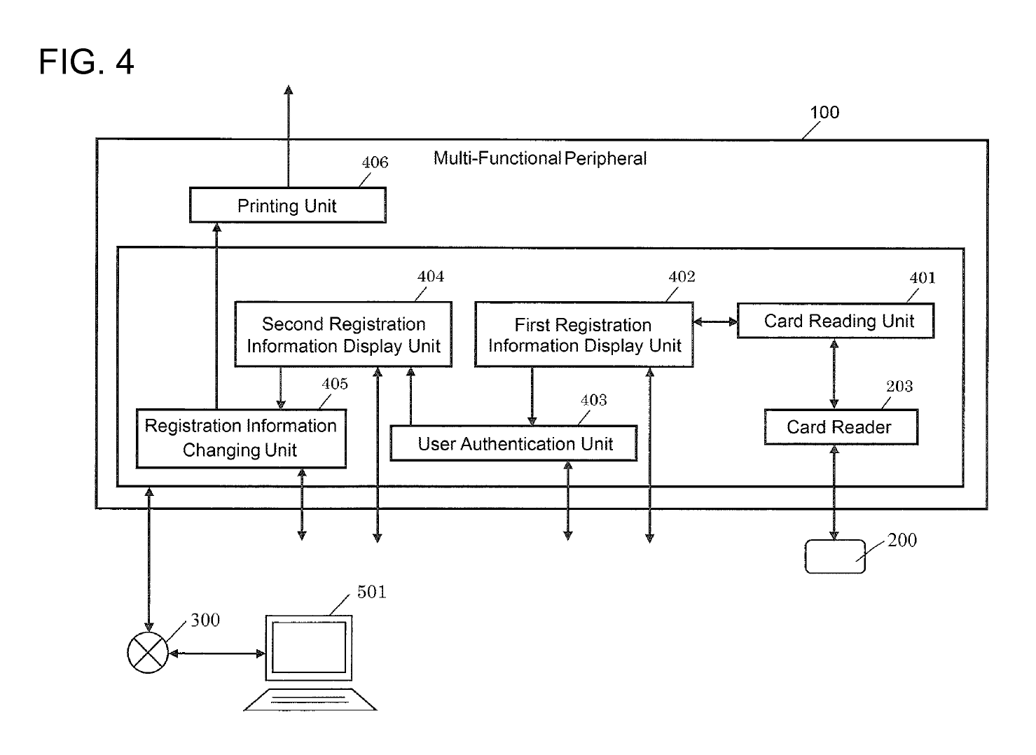

Further, also for the respective units (illustrated in FIG. 4) described later other than the driving units, the CPU ensures the respective units by executing the respective programs. In the ROM, RAM, HDD, and a similar device, programs and data are stored ensuring the respective units described below.

### Embodiment of Disclosure

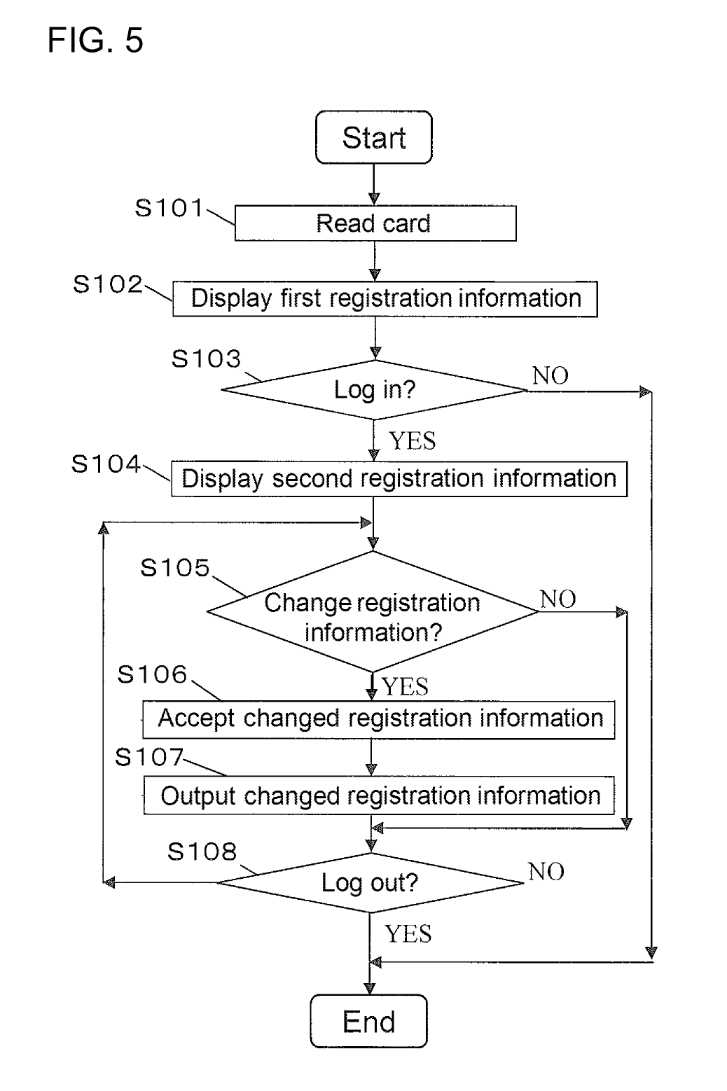

Next, the configuration and execution procedure according to the embodiment of the disclosure will be described with reference to FIG. 4, FIG. 5. FIG. 4 is a function block diagram of the multi-functional peripheral 100 and the display operation unit 101 of the disclosure. Additionally, FIG. 5 is a flowchart so as to illustrate an execution procedure of the disclosure.

Assume that when a user having user's own (electronic) card 200 (for example, point card) goes to the multi-functional peripheral 100 and installs a point card 200 in the card reader 203 of the multi-functional peripheral 100. In this case, a card reading unit 401 of the multi-functional peripheral 100 reads user identification information (for example, the name of the user “AAA”) and card identification information (for example, a name of an issuer “CCC”) stored in the point card 200 with use of the card reader 203 (FIG. 5: S101).

Here, a method with which the card reading unit 401 reads the user identification information and card identification information is not especially limited. For example, when the point card 200 is an IC card and the card reader 203 is non-contact type, the card reading unit 401 reads user identification information and card identification information registered in an IC in the point card 200 with the use of the card reader 203.

Furthermore, when the image reading unit of the multi-functional peripheral 100 is used, the card reading unit 401 displays the screen indicating that the card reading unit 401 causes the user to read one side where the user identification information and card identification information of the point card 200 are described, and causes the user to read one side of the point card 200. Thus, the card reading unit 401 reads the user identification information and card identification information.

Here, the card identification information may include information indicative of the card issuer unambiguously, for example, may include a card number, a name of an issuer, barcode, a store name, an access destination of an issuer, and similar information.

Then when the card reading unit 401 reads the user identification information and card identification information, the card reading unit 401 notifies a first registration information display unit 402 accordingly. The notified first registration information display unit 402 displays card information relating to the point card 200 as a first registration information corresponding to the user identification information “AAA” and card identification information “CCC” read by the card reading unit 401 (FIG. 5: S102).

Here, a method with which the first registration information display unit 402 displays is not especially limited and, for example, the first registration information display unit 402 displays as follows. That is, the first registration information display unit 402, first, specifies the access destination indicating the issuer of the card identification information based on the card identification information “CCC.” Here, when the first registration information display unit 402 specifies the access destination, for example, the card identification information “CCC” may be directly set as the access destination. Further, by an access table, where the card identification information and the access destination are associated, being prepared in the display operation unit 101, the first registration information display unit 402 associates the card identification information in the access table and the card identification information read by the card reading unit 401, and then may specify the access destination of the associated card identification information.

Next, the first registration information display unit 402 accesses the terminal device 501 (the server) of the issuer corresponding to the specified access destination via the network 300.

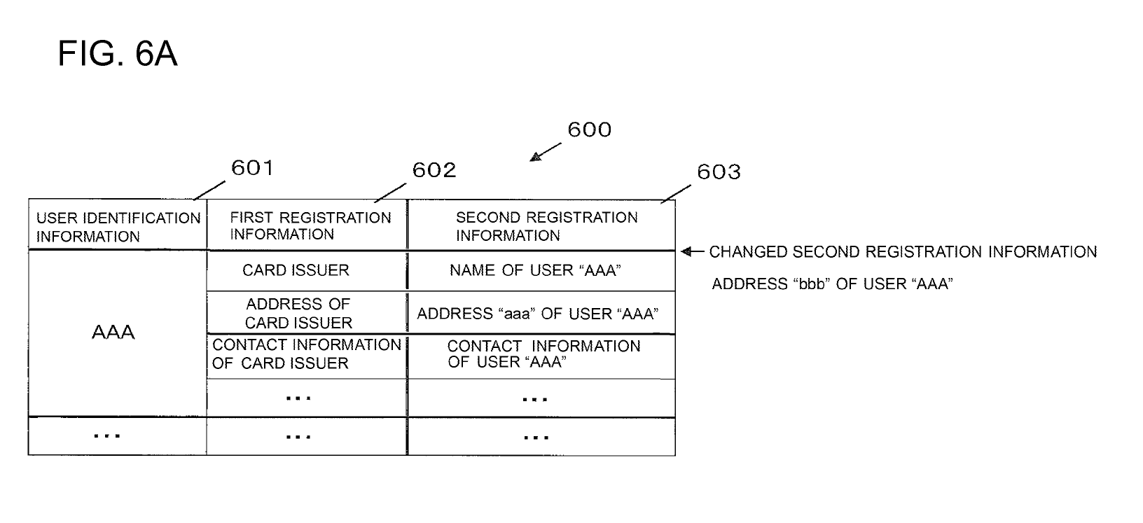

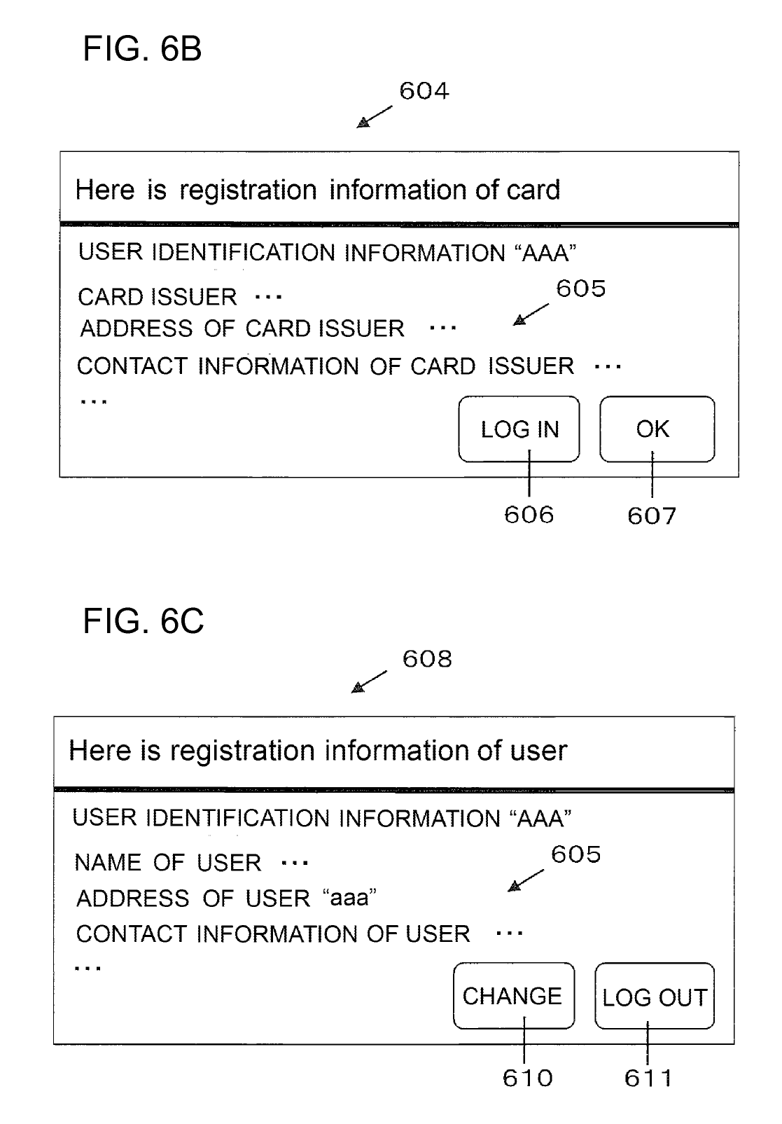

Here, in the server 501 of the issuer, as illustrated in FIG. 6A, user identification information 601, first registration information 602 corresponding to the user identification information 601, and second registration information 603 corresponding to the user identification information 601 are stored preliminarily associated as a registration table 600.

The first registration information display unit 402 associates the user identification information 601 in the registration table 600 and the user identification information “AAA” read by the card reading unit 401 and obtains the first registration information 602 of the associated user identification information 601.

Here, the first registration information 602 may include the information that can identify the issuer, for example, such as the issuer (name) of the card 200 with which the card 200 is distinguishable, the address of the issuer, and the contact information (such as the telephone number) of the issuer. Accordingly, for example, when the user “AAA” lost the card 200, and a third person that picked up the card 200 causes the card 200 to be read, the third person may detect the issuer of the card 200 and use the information as the contact information for the lost card. Further, in the first registration information 602, the information, such as current points or a validated date for a point card, a balance or a validated date for an IC card, a name and a department for an ID card, and the number of printable sheets for a copy card may be included. Furthermore, in the first registration information 602, on the assumption that the user registers, a name or similar information that is simple as personal information may be included.

The first registration information 602 is basically the information described in the card 200 and is limited to the information that a third person can find corresponding to the card 200. However, by a setting by a user, contents of information may be expanded or reduced.

Now, the first registration information display unit 402 displays a first registration information screen 604 on the touch panel 201 based on the obtained first registration information 602 (FIG. 5: S102).

Here, in the first registration information screen 604, as illustrated in FIG. 6B, card issuer information 605, such as a card issuer, an address of card issuer, and contact information of card issuer, as the first registration information 602 is displayed, and a login key 606 for performing user authentication and an OK key 607 are selectably displayed. Thus, the user, first, can confirm the first registration information 602.

Here, when current user is the owner of the card 200 and select the login key 606, the first registration information display unit 402 accepts the selection of the login key 606 and notifies a user authentication unit 403 of the acceptance of the selection of the login key 606. The notified user authentication unit 403 queries the user identification information and the password to the user and executes the user authentication of the user (FIG. 5: S103).

Here, a method with which the user authentication unit 403 performs user authentication is not especially limited. For example, additionally, by a login screen being displayed on the touch panel 201, the user authentication unit 403 accepts the user identification information (“AAA”) and the corresponding password (“zzz”) from the user and verifies the accepted user identification information (“AAA”) against password (“zzz”) with the registered user identification information and registered password for login being preliminarily registered, respectively. Additionally, the registered user identification information and the registered password are, for example, preliminarily set to be stored in a predetermined memory of the display operation unit 101 as a predetermined authentication table.

As a result of the verification, when the accepted user identification information “AAA” and/or password (“zzz”) do not match the registered user identification information and/or registered password (FIG. 5: S103 NO), the user authentication unit 403 terminates the process without logging in the user. This assumed case is the case that the user is a third person other than the owner of the card 200. Further, when the user simply selects the OK key 607 of the first registration information screen 604, similarly the user authentication unit 403 terminates the process without logging in the user.

On the other hand, as a result of the verification, when the accepted user identification information “AAA” and password (“zzz”) match the registered user identification information and registered password (FIG. 5: S103 YES), the user authentication unit 403 log in the user and notifies a second registration information display unit 404 of the login. The notified second registration information display unit 404, corresponding to the user identification information “AAA” and card identification information “CCC”, displays the personal information of the owner (the user) of the point card 200 as the second registration information (FIG. 5: S104).

Here, a method with which the second registration information display unit 404 displays is not especially limited and, for example, the display is performed as the following. That is, the second registration information display unit 404, similarly as described above, specifies the access destination that corresponds to the card identification information “CCC” and accesses to the server 501 of the issuer that corresponds to the specified access destination via the network 300. Then, the second registration information display unit 404 associates the user identification information 601 of the registration table 600 in the server 501 of the issuer and the user identification information “AAA” and obtains the second registration information 603 of the associated user identification information 601.

Here, the second registration information 603 may include the personal information of the owner of the card 200, such as the name of the user, the address of the user, and the contact information (such as a telephone number) of the user. In addition, the second registration information 603 may include a use log or usage conditions of the user having used the card 200.

The second registration information 603 is basically the owner's personal information and, associated with the card 200, is limited to the information that a third person cannot know.

Now the second registration information display unit 404 displays a second registration information screen 608 on the touch panel 201 based on the obtained second registration information 603 (FIG. 5: S104).

Here, in the second registration information screen 608, as illustrated in FIG. 6C, user relevant information 609, such as a name of user, an address of user, and contact information of user, as the second registration information 603 is displayed and a change key 610 for a change of the second registration information 603 and a logout key 611 are selectably displayed. Accordingly, since the volume of the displayed information increases, the user can easily confirm the personal information by login.

Here, when the user, who is looking at the second registration information screen 608, finds an error in an address “aaa” of the user and selects the change key 610 thinking to correct the error immediately, the second registration information display unit 404 accepts the selection of the change key 610 (FIG. 5: S105 YES), and notifies a registration information changing unit 405 of the selection of the change key 610. The notified registration information changing unit 405 queries the changed second registration information to the user and accepts the changed second registration information (FIG. 5: S106).

Here, a method with which the registration information changing unit 405 accepts is not especially limited and, for example, the registration information changing unit 405 additionally displays a registration information acceptance screen, where the changed (new) registration information can be input, on the touch panel 201 and accepts the changed second registration information from the user. For example, when the user, in the registration information acceptance screen, selects the second registration information (the address “aaa” of the user) being before the change and already displayed, and inputs the changed second registration information (the address “bbb” of the user), the registration information changing unit 405 accepts the changed second registration information with respect to the second registration information being before the change. Then, the registration information changing unit 405 accesses the server 501 of the issuer and, as illustrated in FIG. 6A, associates the log of the acceptance of the changed second registration information with the registration table 600. Thus, the registration information changing unit 405 accepts the changed second registration information (FIG. 5: S106). In addition, in this state, the second registration information is not yet changed.

Then, after the acceptance of the changed second registration information, the registration information changing unit 405 outputs the changed second registration information along with the second registration information being before the change and already displayed (FIG. 5: S107).

Here, a method with which the registration information changing unit 405 outputs is not especially limited, and, for example, the registration information changing unit 405 outputs to a printing unit 406 of the multi-functional peripheral 100 by printing of the changed second registration information on a predetermined paper sheet. Thus, for example, the user may use this printed matter as evidence indicating the fact of the change and submit to the issuer of the card 200. In the issuer of the card 200, as described above, since the changed second registration information is stored in the registration table 600 as the log, the issuer verifies the log against the printed matter of the user submitting and then changes the second registration information. Thus, since the issuer can change the user's registration information after the issuer permits the change with respect to the request for the changed registration information from the user, without the user changing the registration information arbitrarily, the user's registration information can be appropriately managed.

Furthermore, when the registration information changing unit 405 outputs the printed matter, configuration of outputting related documents (such as an application form, a procedure, required documents) associated with the change of the registration information of the card 200 together further improves the convenience for the user.

Now, when the user, who is looking at the second registration information screen 608, selects the logout key 611, the second registration information display unit 404 accepts the selection of the logout key 611 (FIG. 5: S108 YES) and notifies the user authentication unit 403 of the selection of the logout key 611. The notified user authentication unit 403 logouts the user and terminates the whole process. Additionally, at S105, also when the user, who is looking at the second registration information screen 608, does not change the registration information (FIG. 5: S105 NO) and selects the logout key 611 (FIG. 5: S108 YES), similarly the user authentication unit 403 logouts the user and terminates the whole process.

Accordingly, the disclosure is characterized by including the first registration information display unit 402, the user authentication unit 403, and the second registration information display unit 404. When user identification information and card identification information of a card are read, the first registration information display unit 402, corresponding to the user identification information and card identification information, displays card information relating to the card as first registration information. The user authentication unit 403 executes user authentication after the first registration information is displayed. When, as a result of the user authentication, login is executed, the second registration information display unit 404, corresponding to the user identification information and the card identification information, displays personal information of the owner of the card as second registration information. Thus, the registration information registered in the card can be safely and accurately confirmed.

Additionally, in the embodiment of the disclosure, any registration information changing unit 405 of the display operation unit 101 is configured to query the changed second registration information to the user and accept the changed second registration information, however other configurations may be applicable. For example, the registration information changing unit 405 obtains identification information (such as location information) of the unit itself (the display operation unit 101) and verifies the obtained identification information against preliminarily registered identification information (of a permitted unit where change of registration information is permitted). When both of the identification information are matched, the registration information changing unit 405 may be configured to accept the changed second registration information from the user. When both of the identification information are not matched, the registration information changing unit 405 does not accept the changed second registration information from the user. Thus, from a viewpoint of security, only an apparatus situated in a limited place can be configured to accept a change of registration information from a user.

Furthermore, in the embodiment of the disclosure, the display operation unit 101 and the multi-functional peripheral 100 are configured to include the respective units. However it may be configured that programs which ensure the respective units are stored in a non-transitory storage medium and the storage medium is provided. This configuration causes the display operation unit 101 to read the programs, and the display operation unit 101 ensures the respective units. In this case, the program itself being read from the recording medium achieves the operational advantages of the disclosure. Furthermore, the recording medium may be provided as a method causing the steps that the respective units executes to be stored in a hard disk.

As described above, the display operation apparatus and the display operation method according to the disclosure are useful, not merely for a multi-functional peripheral, for a display operation apparatus such as copier, printer, terminal device, tablet type terminal device, laptop personal computer, and portable terminal device. Furthermore, the display operation apparatus and the display operation method according to the disclosure are effective as the display operation apparatus and the display operation method capable of confirming registration information registered in a card safely and accurately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A display operation apparatus using a card, comprising:
a first registration information display unit that displays card information related to the card as first registration information corresponding to user identification information and card identification information of the card when the user identification information and the card identification information are read;
a user authentication unit that executes user authentication after the first registration information is displayed; and
a second registration information display unit that displays personal information of an owner of the card as second registration information corresponding to the user identification information and the card identification information when login is executed as a result of the user authentication.

2. The display operation apparatus according to claim 1, further comprising:
a registration information changing unit that queries a user as to changed second registration information, accepts changed second registration information, and outputs the changed second registration information along with the second registration information before the change, when the second registration information is displayed.

3. The display operation apparatus according to claim 2, wherein:
the registration information changing unit obtains identification information of the display operation apparatus, verifies the obtained identification information against preliminarily registered identification information, accepts the changed second registration information from the user if the obtained and the registered identification information match, and does not accept the changed second registration information from the user if the obtained and the registered identification information do not match.

4. A display operation method using a card, comprising:
displaying card information related to the card as first registration information corresponding to user identification information and card identification information of the card when the user identification information and the card identification information are read;
executing user authentication after the first registration information is displayed; and
displaying personal information of an owner of the card as second registration information corresponding to the user identification information and the card identification information when login is executed as a result of the user authentication.

5. A non-transitory computer-readable recording medium storing an information processing program to control a display operation apparatus using a card, the information processing program causing the display operation apparatus to function as:
a first registration information display unit that displays card information related to the card as first registration information corresponding to user identification information and card identification information of the card when the user identification information and the card identification information are read;
a user authentication unit that executes user authentication after the first registration information is displayed; and
a second registration information display unit that displays personal information of an owner of the card as second registration information corresponding to the user identification information and the card identification information when login is executed as a result of the user authentication.
